(19) United States
(12) Patent Application Publication
(10) Pub. No.: US 2008/0121590 A1
(43) Pub. Date: May 29, 2008

(54) By-pass system for separating untreated water from treated water within a water treatment system

(75) Inventors: Kemp Falkner, Jacksonville, FL (US); Christopher Kampf, Johnston, RI (US)

Correspondence Address: EDWARDS ANGELL PALMER & DODGE LLP, P.O. BOX 55874, BOSTON, MA, 02205, US

(73) Assignees: Amtrol Licensing Inc.; West Warwick, R.I.

(21) Appl. No.: 11/982,050

(22) Filed: Nov. 1, 2007

Related U.S. Application Data
(60) Provisional application No. 60/856,185, filed on Nov. 2, 2006.

(51) Int. Cl. B01D 35/147; C02F 1/00

(52) U.S. Cl. 210/741; 210/136; 210/133; 210/747

(57) ABSTRACT

A water treatment system includes a pump adapted and configured to pressurize a flow of untreated water. A water treatment tank downstream from the pump includes an inlet in fluid communication with an outlet of the pump and an outlet in fluid communication with an outlet line. A check valve downstream from the water treatment tank includes an inlet in fluid communication with the outlet line of the water treatment tank. The check valve is adapted and configured to permit fluid flow therethrough only in a direction that permits the water treatment tank to evacuate water through the outlet line of the water treatment tank. A flow manifold includes a first inlet in fluid communication with an outlet of the check valve, a second inlet in fluid communication with an outlet of the pump, and an outlet.

### CROSS REFERENCE TO RELATED APPLICATIONS

This application claims benefit of priority to U.S. Provisional Patent Application No. 60/856,185 filed Nov. 2, 2006, which is incorporated by reference herein in its entirety.

### BACKGROUND OF THE INVENTION

1. Field of the Invention

The subject invention is directed to water treatment systems, and more particularly, to a new and useful bypass configuration for separating treated water from high flow raw untreated irrigation water.

2. Description of Related Art

A variety of devices are known in the art for treatment of water. Of such devices, many are directed to removal of undesirable chemicals, minerals, organisms, and other material contained in raw water. Treatment of raw water can remove unpleasant odors and can make water safe for drinking and other uses within a home, office, restaurant, etc.

There are also many uses of water that do not require such treatment. General irrigation needs, such as for watering lawns, gardens, running fountains, exterior cleaning, and other such uses do not necessarily require. In many situations, such as a home or business, treated water is needed for many purposes, but there still remains a frequent need of water for irrigation purposes. When known water treatment systems are used in such a setting, all water including irrigation water ends up being treated. However, using treated water for irrigation purposes is wasteful of the resources expended in treating the water.

Such conventional methods and systems generally have been considered satisfactory for their intended purpose. However, the need for both treated and untreated water from the same system leads to unnecessary water treatment costs. There still remains a continuing need in the art for a water treatment system that can separate treated water from untreated water used for irrigation purposes. There also remains a need in the art for such a system that is inexpensive and easy to make and use. The present invention provides a solution for these problems.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied herein and broadly described, the invention includes a water treatment system. The water treatment system includes a pump adapted and configured to pressurize a flow of untreated water. A water treatment tank downstream from the pump includes an inlet in fluid communication with an outlet of the pump and an outlet in fluid communication with an outlet line. A check valve downstream from the water treatment tank includes an inlet in fluid communication with the outlet line of the water treatment tank. The check valve is adapted and configured to permit fluid flow therethrough only in a direction that permits the water treatment tank to evacuate water through the outlet line of the water treatment tank. The system further includes a flow manifold including a first inlet in fluid communication with an outlet of the check valve, a second inlet in fluid communication with an outlet of the pump, and an outlet.

In accordance with a further aspect of the invention, the system further includes a pressure reducing valve having an inlet in fluid communication with the outlet of the flow manifold. The system can further include an irrigation system having an inlet in fluid communication with an outlet of the pressure reducing valve.

The pressure reducing valve can include a spring element adapted to deflect under a predetermined force, wherein the spring has a spring constant that is proportional to a pressure drop imposed by the pressure reducing valve. The pressure reducing valve can be adapted and configured to provide a substantially constant pressure drop over a range of flow rates. The range of flow rates can be between about 0 gallons per minute and about 30 gallons per minute, or any other suitable range for a given application.

In accordance with another aspect of the invention, the water treatment tank further includes a second outlet in fluid communication with a holding tank adapted and configured to store treated water. The holding tank can further include an outlet line having a flow restrictor therein to supply a maximum predetermined amount of water to a user. In another aspect of the invention, the check valve can be modular.

The invention also includes a method of operating a water treatment system to bypass flow of untreated water to an irrigation system. The method includes opening a valve to place an irrigation system in fluid communication with a water treatment tank adapted and configured to treat untreated water. The method also includes initially directing water from the water treatment tank through a check valve into the irrigation system.

In accordance with a further aspect of the invention, the step of initially directing water includes directing water from the water treatment tank into the irrigation system through a pressure reducing valve. The method can further include activating a pump to pressurize a source of untreated water upstream of the water treatment tank to a pressure in excess of water pressure on an upstream side of the check valve. Untreated water can be directed through the pressure reducing valve into the irrigation system. Closing the check valve prevents untreated water from entering the water treatment tank by way of the check valve and prevents flow of treated water to the irrigation system.

The pump can be activated in response to a signal indicating that a pressure drop has occurred in the water treatment tank due to the irrigation system being activated. The method can further include closing the valve to stop flow to the irrigation system. It is also contemplated that the method can further include recharging the water treatment tank with water from the pump, and deactivating the pump.

The invention also includes a bypass system for separating treated water from untreated water within a water treatment system. The bypass system includes a check valve adapted and configured to be positioned downstream from a water treatment tank containing treated water. The check valve has an inlet in fluid communication with an outlet line of the water treatment tank. The check valve is adapted and configured to permit fluid flow therethrough only in a direction that permits the water treatment tank to evacuate water through the outlet line of the water treatment tank. The bypass system further includes a flow manifold having a first inlet in fluid communication with an outlet of the check valve, a second inlet in fluid communication with an outlet of a pump, and an outlet.

In further accordance with the invention, the bypass system further includes means for controlling pressure having an inlet in fluid communication with the outlet of the flow manifold and an outlet adapted and configured to be placed in fluid communication with an irrigation system. The pressure reducing valve can include a spring element adapted to deflect under a predetermined force. The spring can have a spring constant that is proportional to a pressure drop imposed by the pressure reducing valve. The pressure reducing valve can be adapted and configured to provide a substantially constant pressure drop over a range of flow rates. The range of flow rates can be between about 0 gallons per minute and about 30 gallons per minute, or any other suitable range for a given application.

In accordance with still another aspect of the invention, the check valve is modular. It is contemplated that the bypass system can further include an inductor having an inlet in fluid communication with the outlet of the pump, and having an outlet configured and adapted to be placed in fluid communication with the treatment tank.

The invention further includes a modular flow restrictor. The flow restrictor includes a first body portion defining a flow inlet with a first flow passage therethrough having a first diameter. The first body portion has a first set of threads thereon. A second body portion defines a flow outlet and has a second set of threads adapted and configured to mate with the first set of threads. A third body portion defines a second flow passage therethrough having a second diameter. The second flow passage is in fluid communication with the first flow passage. The third body portion is adapted and configured to be received by the second body portion. An orifice plate having a body defining a flow orifice therethrough has a third diameter substantially smaller than the first diameter and second diameter. The orifice plate is adapted and configured to be removably captured between the first, second and third body portions when the threads are tightened.

The invention also includes a modular check valve. The modular check valve includes a first body portion defining a flow inlet with a first flow passage therethrough having a first diameter. The first body portion has a first set of threads thereon. A second body portion defines a flow outlet. The second body portion has a second set of threads adapted and configured to mate with the first set of threads. A third body portion defines a second flow passage therethrough having a second diameter. The second flow passage is in fluid communication with the first flow passage. The third body portion is adapted and configured to be received by the second body portion. A check valve sub-assembly is adapted and configured to be removably captured between the first, second, and third body portions when the threads are tightened. At least one of the first body portion, the second body portion, the third body portion, and the check valve sub-assembly can include a plastic or any other suitable material.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic view of a first representative embodiment of a water treatment system in accordance with the present invention.

FIG. 2(A) is an exploded perspective view of an embodiment of a check valve made in accordance with another aspect of the present invention.

FIG. 2(B) is a side elevation view of the check valve of FIG. 2(A) in accordance with the present invention, showing the first, second, and third bodies of the check valve threaded together.

FIG. 2(C) is an end view of the check valve of FIG. 2(B) in accordance with the present invention, showing the check valve sub-assembly.

FIG. 2(D) is cross-sectional side elevation view of the check valve of FIG. 2(B) in accordance with the present invention, showing the internal components of the assembled check valve.

FIG. 3(A) is an exploded perspective view of an embodiment of a flow restrictor made in accordance with the present invention.

FIG. 3(B) is a perspective view of the flow restrictor of FIG. 3(A) in accordance with the present invention, showing the flow restrictor components assembled together.

FIG. 3(C) is an end view of the flow restrictor of FIG. 3(B) in accordance with the present invention, showing the orifice plate.

FIG. 3(D) is a cross-sectional side elevation view of the flow restrictor of FIG. 3(B) in accordance with the present invention, showing the internal components of the assembled flow restrictor.

FIG. 3(E) is a cross-sectional side elevation view of a portion of the flow restrictor of FIG. 3(D) in accordance with the present invention, showing the components of the orifice disc in greater detail.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

The devices and methods presented herein may be used for separating flows of treated water from flows of untreated water. The present invention is particularly suited for separating flows of raw untreated water for use in irrigation from treated water.

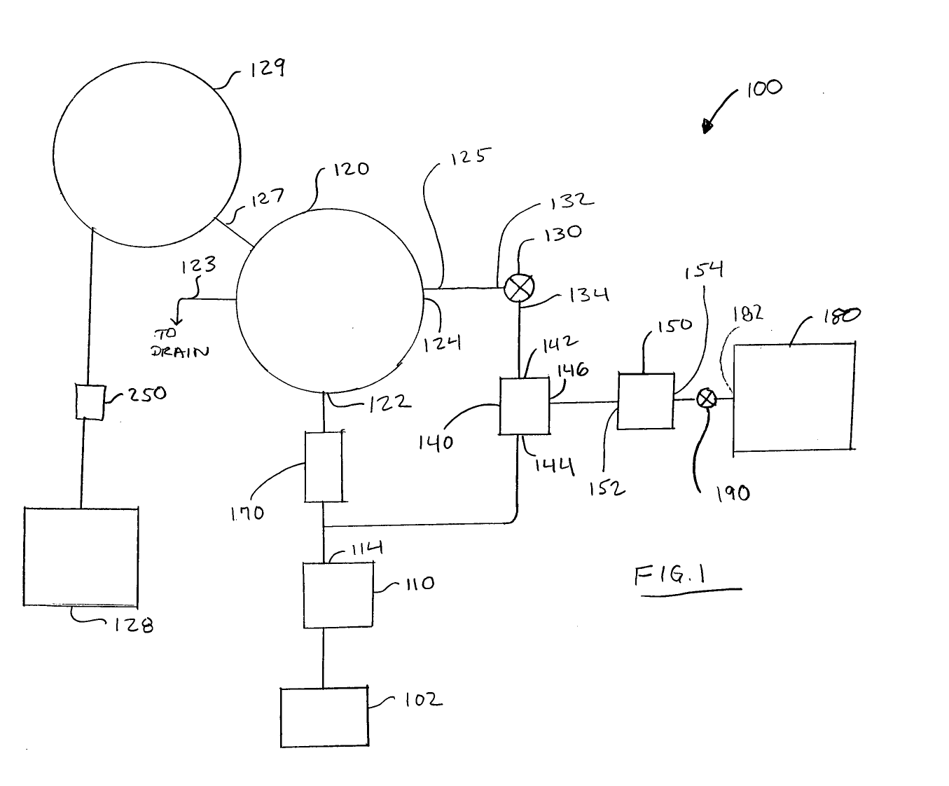

In accordance with the invention, a water treatment system is provided. For purposes of illustration, and not limitation, as embodied herein and as depicted in FIG. 1, a water treatment system 100 is provided including a pump 110 adapted and configured to pressurize a flow of untreated water from a source of water 102 (such as a well, river, lake or other source). During normal system operation, when system is used to create drinking water, water pressurized by pump 110 is directed to a water treatment tank 120.

Water treatment tank 120 is located downstream from pump 110, and includes an inlet 122 in fluid communication with an outlet 114 of the pump 110 by way of inductor 170, described below. Tank 120 further includes a first outlet 124 in fluid communication with an outlet line 125. As depicted in FIG. 1, outlet line 125 directs treated water to a check valve 130, described in detail below. As is further depicted, a second outlet line 127 is provided to direct treated water to a holding tank 129, which in turn can direct treated water to a downstream location 128 (such as a house, restaurant, office building or the like) where treated water is needed. If desired, a flow restrictor 250 may be provided to limit the output of holding tank 129 to reduce the risk of exhausting the supply of treated water in holding tank 129 during periods of peak demand. Flow restrictor 250 is described in detail below. A drain 123 is also provided for periodically flushing precipitate and other impurities from tank 120.

Water treatment tank 120 can be adapted and configured to perform any desired treatment operation on water. In a preferred embodiment of the subject invention, the water treatment tank 120 is used for removing hydrogen sulfide from well water. A particularly useful system for hydrogen sulfide removal is manufactured and sold by Amtrol of West Warwick, R.I. under the tradename ODOR OXIDIZER® and is disclosed in U.S. Pat. No. 6,080,306 to Falkner, the disclosure of which is herein incorporated by reference in its entirety. U.S. Pat. No. 6,481,456 discloses a method and an air control valve for operating such a tank, and is also incorporated by reference herein in its entirety. This water treatment system uses ambient oxygen to convert hydrogen sulfide into water and precipitated sulfur. The precipitant is collected in a sump and flushed from the system periodically. It will be appreciated that other types of water treatment tanks to perform other types of treatments can be used.

As is further depicted in FIG. 1, a check valve 130 is located downstream from the water treatment tank 120 along a direction that leads to an irrigation system 180, discussed in detail below. Check valve 130 includes an inlet 132 in fluid communication with the outlet line 125 of the water treatment tank 120 and an outlet 134. Check valve 130 is adapted and configured to permit flow in only one direction. Preferably, check valve 130 is arranged to permit fluid flow therethrough only in a direction that permits the water treatment tank 120 to evacuate water through outlet line 125. Check valve 130 is adapted to close if the pressure proximate the outlet 134 of check valve 130 exceeds the pressure proximate the inlet 132 of check valve 130.

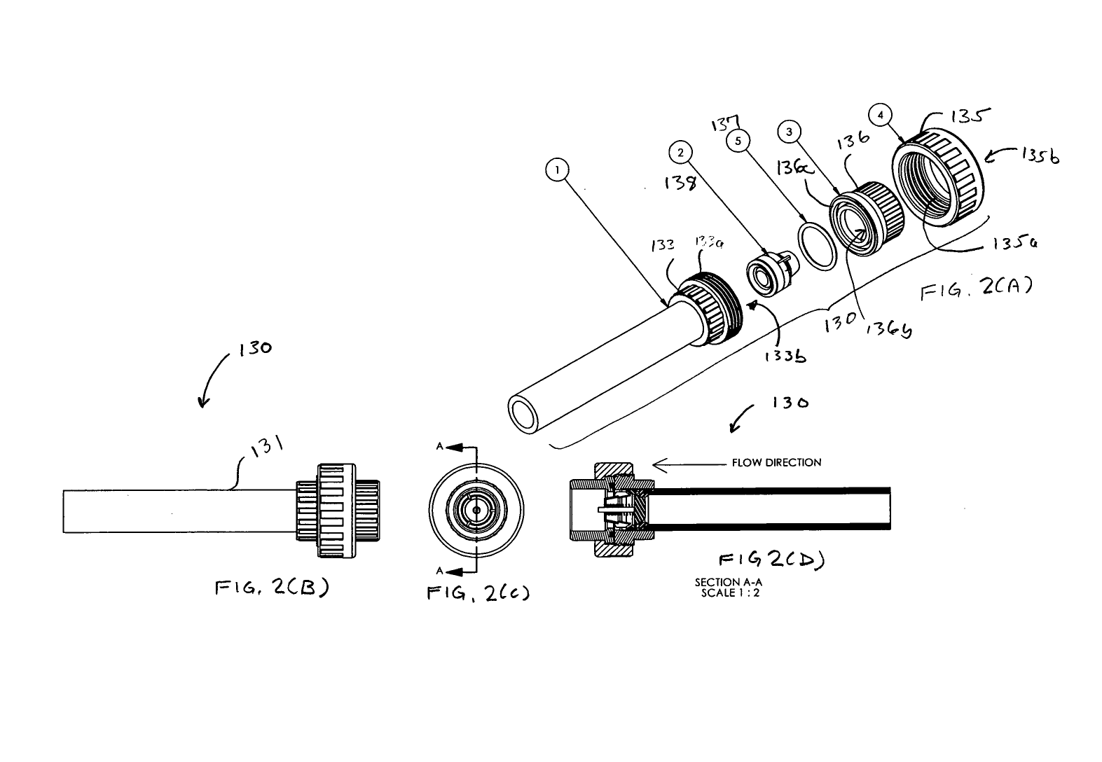

An exploded view of an exemplary embodiment of a check valve 130 is depicted in FIG. 2(A). Views of assembled check valve 130 are shown in FIG. 2(B)-(D). Check valve 130 includes a pipe portion 131, if desired, a first body portion 133 having a first plurality of threads 133a formed thereon and defining a flow passage 133b therethrough, a second body portion 135 having a second plurality of threads 135a formed thereon and a second passage 135b defined therethrough. Third body portion 136 is also provided defining a flow passage 136b therethrough. Third body portion 136 is configured to be received by second body portion 135. A seal 137 is provided that is adapted and configured to be received by an outer peripheral portion 136c of third body portion 136.

A check valve subassembly 138 is adapted and configured to be removably received by third body portion 136, seal 137 and first body portion 133, and to be captured therebetween when the threads are tightened. Second body portion 135 may be threaded to first body portion 133 to form the assembly. It will be appreciated that check valve 130 can be made from a variety of materials, such as metal, plastic, any other suitable material, or combinations thereof. It will be further appreciated that check valve 130 can be made in any size and may be used in any suitable application. Check valve subassembly 138 may be, for example, an industry standard check valve.

With reference again to FIG. 1, a flow manifold 140 is also provided. As depicted, flow manifold 140 includes a first inlet 142 in fluid communication with the outlet 134 of check valve 130. Flow manifold 140 further includes a second inlet 144. As depicted, second inlet 144 is adapted to be in fluid communication with the outlet 114 of pump 110. As further depicted, flow manifold 140 also includes an outlet 146. It will be appreciated that flow manifold 140 can be made in a variety of manners. In accordance with one embodiment of the invention, flow manifold 140 is a T-shaped piece of pipe or conduit that is adapted and configured to be placed in fluid communication with other portions of system 100. While FIG. 1 shows one location for manifold 140, any location on the water line between pump 110 and check valve 130 can be used. Moreover, those skilled in the art will readily appreciate that manifold 140 can be located in any other suitable location without departing from the spirit and scope of the invention.

As is further depicted in FIG. 1, the outlet 146 of flow manifold 140 is in fluid communication with a pressure reducing valve 150. Pressure reducing valve 150 includes means for reducing the pressure in a flow passing therethrough. This can be particularly advantageous when it is desired to connect two fluid systems that operate best at different pressures. In accordance with one embodiment of an invention disclosed herein, the downstream portion of a flow system connected to pressure reducing valve 150 is connected to irrigation system 180, and the portion upstream of the pressure reducing valve 150 is connected to water treatment system 120 and pump 110 via flow manifold 140.

A pressure regulating valve or pressure limiting valve can readily be used in lieu of pressure reducing valve 150. Moreover, those skilled in the art will readily appreciate that any suitable pressure controlling means can be used without departing from the spirit and scope of the invention. For example, if raw system operation needs maximum deliverable pressure, a pressure regulating valve or pressure limiting valve could be used. Those skilled in the art will readily appreciate how to configure the system to include appropriate pressure controlling means for specific applications.

Pressure reducing in this valving application means a select amount of pressure is always deducted from the inlet pressure, no matter the amount of pressure or flow. The flow is always impeded through the valve to maintain a constant specific inlet pressure reduction. Pressure regulating in this valving application means the pressure cannot exceed a selected pressure down stream of the valve, no matter how much higher the pressure is upstream. When the inlet pressure is equal to or less than the selected down stream pressure, the flow and pressure are unimpeded through the valve.

In accordance with the exemplary water treatment systems embodied herein, it is advantageous to entrain air in the water stream that enters water treatment tank 120 by way of an inductor 170. Suitable inductors 170 and the use thereof are described, for example, in U.S. Pat. No. 7,125,003 to Falkner, which is incorporated by reference herein in its entirety. It is sometimes desirable to operate such inductors with a large input pressure to permit sufficient air to be entrained in water passing therethrough by passing the water through a venturi portion of the inductor, which imposes a large pressure drop on the fluid. As such, it may be desirable to operate such a water treatment system at an input pressure upstream of the inductor 170 in the range of about 90-110 psi. However, irrigation systems tend to be designed to operate at lower pressures, such as about 60-80 psi. Operating an irrigation system above the pressure at which it is designed to operate can result in damage to the system.

However, by using a pressure reducing valve 150, it is possible to reduce the pressure in the fluid provided by pump 110 to a level that is suitable for an irrigation system. As such, pressure reducing valve 150 includes an inlet 152 in fluid communication with the outlet 146 of flow manifold 140. A variety of pressure reducing flow structures may be included in pressure reducing valve 150. For example, pressure reducing valve 150 can be constructed similarly to inductor 170, but the venturi portion of the inductor can be blocked so that fluid only flows through the bypass system (including valve closure assembly 50 and spring 55 described, for example, at Cols. 3 and 4 of U.S. Pat. No. 7,125,003, incorporated by reference herein in its entirety).

The pressure is reduced in correlation with the constant of the spring in the bypass portion of the inductor. Those skilled in the art will readily appreciate that the spring can be adapted to deflect under a predetermined force. It will be appreciated that a pressure reducing valve without the other portions of inductor 170 could also be used, including a spring biased valve. Different pressure drops can be realized accordingly by using springs having different wire gages, hardnesses and materials, as desired. Advantageously, using a pressure reducing valve 150 such as that disclosed herein permits a substantially constant reduction in pressure over a variety of flow rates over an extended range, such as 0-30 gallons per minute, or any other suitable flow range that is suitable for a given application.

As further depicted in FIG. 1, an irrigation system 180 is schematically represented having an inlet 182 in fluid communication with an outlet 154 of the pressure reducing valve 150. As described above, in operation, pump 110 can pressurize fluid in system 100 to a first predetermined value, which can in turn be reduced to a second pressure value by pressure reducing valve 150 for use by irrigation system 180. It will be appreciated that irrigation system 180 can include any suitable components, such as sprinklers, soaker hoses, fountains, ponds and the like. Since untreated raw water is used to perform irrigation, treated water from tank 120 is not wasted. It will be appreciated that while raw water is depicted as being directed to an irrigation system, it may additionally or alternatively be directed to any other suitable end use where raw water is needed, such as commercial raw water requirements, and the like.

It will be appreciated that the components of system 100 can be made from any suitable material. Preferably, portions of system 100 are made from high grade pressure resistant plastic such as polyvinylchloride (“PVC”) or other suitable plastics such as chlorinated polyvinylchloride (“CPVC”) or polyethylene (“PE”), among others. It will also be appreciated that any number of systems 100 can be placed in parallel for supplying any needed amount of treated and raw water.

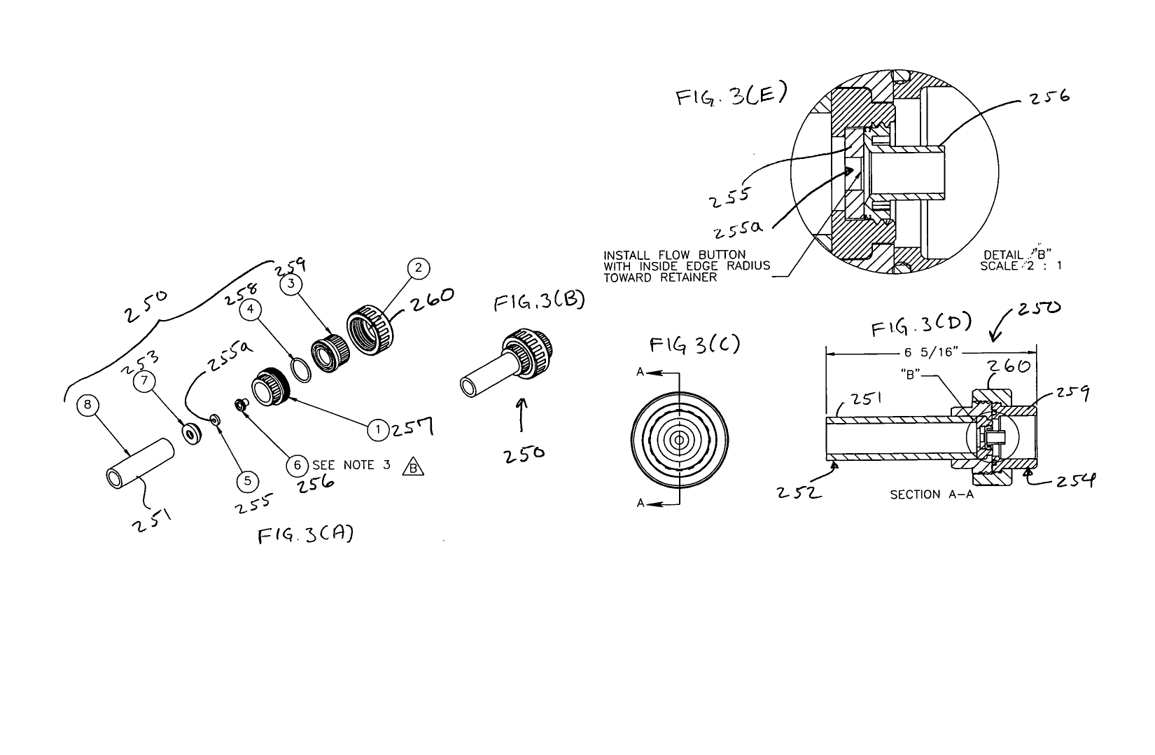

In further accordance with the invention, a novel flow restrictor is also provided. For purposes of illustration and not limitation, as embodied herein and as depicted in FIGS. 3(A)-3(E), a flow restrictor 250 is provided. As depicted, flow restrictor 250 includes a pipe portion 251, if desired, a drain line button support 253 adapted and configured to support an orifice plate or flow control button 255 having a flow orifice 255a, a drain line button retainer 256 for supporting orifice plate 255, a first threaded union portion 257, a seal 258, a second internally threaded union portion 260, and a third union portion 259. Third portion 259 is configured to be received by second portion 260 so that when first portion 257 is threaded to second portion 260, a flow passage is defined through first portion 257 and third portion 259.

The orifice plate or flow control button 255 can have a body defining a flow orifice therethrough that has a diameter substantially smaller than the diameters of first portion 257 and third portion 259. Orifice plate or flow control button 255 can be captured between the first portion 257, second portion 260, and third portion 259 when the threads are tightened. Those skilled in the art will readily appreciate that it is possible to make flow restrictor 250 modular without departing from the spirit and scope of the invention.

As depicted in FIG. 3(A)-(E), restrictor 250 is adapted to be assembled manually to facilitate replacement of orifice plate 255 in case of failure, or to permit easy modification to use orifice plates 255 with different size orifices. It will be appreciated that restrictor 250 can be made from a variety of materials, such as metal, plastic, any other suitable material, or combinations thereof. It will be further appreciated that restrictor 250 can be made in any size, can be configured to accommodate any desired flow rate and may be used in any suitable application.

In further accordance with the invention, a method is provided herein for operating a water treatment system to bypass flow of untreated water to an irrigation system. For purposes of illustration and not limitation, as embodied herein, the method of the invention can be practiced using any suitable combination of flow hardware, such as the physical system 100 depicted herein. Using the embodiment of FIG. 1 as an exemplary reference point, the method first includes placing an irrigation system in fluid communication with a water treatment system adapted and configured to treat untreated water, such as by opening a valve. A suitable valve 190 can be supplied for selectively placing irrigation system 180 in fluid communication with the other portions of system 100.

Next, in accordance with one embodiment of the invention, treated water can initially be directed from pressurized tank 120 through check valve 130 and pressure reducing valve 150 to provide an initial supply of water to irrigation system 180. This is advantageous, for example, when only small amounts of water are needed for irrigation purposes because it avoids frequent activating and deactivating the pump. Thus using small amounts of treated water from the treatment tank saves wear and tear on the pump and since the amounts are small, there is little waste of treated water.

However, it is not desirable to irrigate exclusively with treated water, especially when large amounts of irrigation water are required, due to the waste involved with treating irrigation water. Therefore, when large amounts of irrigation water are needed, the treatment tank is bypassed. At a particular point shortly after the irrigation system 180 is switched on, pump 110 may be activated to provide pressurized raw water from a source 102 upstream of system 100 for use by irrigation system 180. This is advantageous because it prevents wasting large amounts of treated water on irrigation needs.

If the pressure in flow manifold 140 exceeds that upstream of check valve 130, check valve 130 moves to a closed position, thereby isolating treated water in tank 120, and preventing backflow of untreated water into tank 120. Raw, untreated water is accordingly directed through pressure reducing valve 150 into the irrigation system 180. The pump may be activated, for example, in response to a signal indicating that a pressure drop has occurred in the water treatment system due to the irrigation system being activated. The pressure signal may be obtained from a point within tank 120, or other suitable location. For example, if desired, a mechanical pressure switch or digital pressure controller may be mounted near tank 120 and connected to tank 120 by way of a flexible pressure line.

After irrigating, valve 190 can be used to close off flow to irrigation system 180. At such time, pump 110 can be deactivated. It is also possible that before pump 110 is deactivated, it can continue to operate until treatment tank 120 is recharged to full pressure. A sensor in or connected to tank 120 can be used to deactivate pump 110 when tank 120 is at full pressure. Those skilled in the art will appreciate that tank 120 can also be configured to be replenished while irrigating.

It will be appreciated that a bypass system may be bundled with a water treatment system as described herein, or individually. As such, the invention also provides a bypass system for separating treated water from untreated water within a water treatment system.

For purposes of illustration and not limitation, the system includes a check valve (such as check valve 130) adapted and configured to be positioned downstream from a water treatment tank (such as tank 120) containing treated water. The check valve is preferably adapted and configured to permit fluid flow therethrough only in a direction that permits the water treatment tank to evacuate water through the outlet line of the water treatment tank. The bypass system further includes a flow manifold (such as 140) having a first inlet (e.g., 142) in fluid communication with an outlet of the check valve, a second inlet (e.g., 144) in fluid communication with an outlet of a pump and an outlet (e.g., 146). The bypass system also preferably includes a pressure reducing valve (e.g., 150) having an inlet in fluid communication with the outlet of the flow manifold and an outlet adapted and configured to be placed in fluid communication with an irrigation system.

The methods and systems of the present invention, as described above and shown in the drawings, provide for a flow bypass system and water treatment system with superior properties and functionality to those of the prior art. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A water treatment system, comprising:
a) a pump adapted and configured to pressurize a flow of untreated water;
b) a water treatment tank downstream from the pump having:
i) an inlet in fluid communication with an outlet of the pump;
ii) an outlet in fluid communication with an outlet line;
c) a check valve downstream from the water treatment tank, the check valve having an inlet in fluid communication with the outlet line of the water treatment tank, the check valve being adapted and configured to permit fluid flow therethrough only in a direction that permits the water treatment tank to evacuate water through the outlet line of the water treatment tank; and
d) a flow manifold having:
i) a first inlet in fluid communication with an outlet of the check valve;
ii) a second inlet in fluid communication with an outlet of the pump; and
iii) an outlet.

2. A water treatment system as recited in claim 1, further comprising a pressure reducing valve having an inlet in fluid communication with the outlet of the flow manifold.

3. A water treatment system as recited in claim 2, further comprising an irrigation system having an inlet in fluid communication with an outlet of the pressure reducing valve.

4. A water treatment system as recited in claim 2, wherein the pressure reducing valve includes a spring element adapted to deflect under a predetermined force, the spring having a spring constant that is proportional to a pressure drop imposed by the pressure reducing valve.

5. A water treatment system as recited in claim 4, wherein the pressure reducing valve is adapted and configured to provide a substantially constant pressure drop over a range of flow rates.

6. A water treatment system as recited in claim 5, wherein the range of flow rates is between about 0 gallons per minute and about 30 gallons per minute.

7. A water treatment system as recited in claim 1, wherein the water treatment tank further includes a second outlet in fluid communication with a holding tank adapted and configured to store treated water.

8. A water treatment system as recited in claim 7, wherein the holding tank further includes an outlet line having a flow restrictor therein to supply a maximum predetermined amount of water to a user.

9. A water treatment system as recited in claim 1, wherein the check valve is modular.

10. A method of operating a water treatment system to bypass flow of untreated water to an irrigation system, comprising:
a) opening a valve to place an irrigation system in fluid communication with a water treatment tank adapted and configured to treat untreated water; and
b) initially directing water from the water treatment tank through a check valve into the irrigation system.

11. A method as recited in claim 10, wherein the step of initially directing water includes directing water from the water treatment tank into the irrigation system through a pressure reducing valve.

12. A method as recited in claim 11, further comprising:
a) activating a pump to pressurize a source of untreated water upstream of the water treatment tank to a pressure in excess of water pressure on an upstream side of the check valve; and
b) directing untreated water through the pressure reducing valve into the irrigation system and closing the check valve to prevent untreated water from entering the water treatment tank by way of the check valve and to prevent flow of treated water to the irrigation system.

13. A method as recited in claim 12, wherein the pump is activated in response to a signal indicating that a pressure drop has occurred in the water treatment tank due to the irrigation system being activated.

14. A method as recited in claim 13, further comprising:
a) closing the valve to stop flow to the irrigation system.

15. A method as recited in claim 14, further comprising:
a) recharging the water treatment tank with water from the pump; and
b) deactivating the pump.

16. A bypass system for separating treated water from untreated water within a water treatment system, comprising:
a) a check valve adapted and configured to be positioned downstream from a water treatment tank containing treated water, the check valve having an inlet in fluid communication with an outlet line of the water treatment tank, the check valve being adapted and configured to permit fluid flow therethrough only in a direction that permits the water treatment tank to evacuate water through the outlet line of the water treatment tank; and
b) a flow manifold having:
i) a first inlet in fluid communication with an outlet of the check valve;
ii) a second inlet in fluid communication with an outlet of a pump; and
iii) an outlet.

17. A bypass system as recited in claim 16, further comprising means for controlling pressure having an inlet in fluid communication with the outlet of the flow manifold and an outlet adapted and configured to be placed in fluid communication with an irrigation system.

18. A bypass system as recited in claim 17, wherein the pressure reducing valve includes a spring element adapted to deflect under a predetermined force; the spring having a spring constant that is proportional to a pressure drop imposed by the pressure reducing valve.

19. A bypass system as recited claim 18, wherein the pressure reducing valve is adapted and configured to provide a substantially constant pressure drop over a range of flow rates.

20. A bypass system as recited claim 19, wherein the range of flow rates is between about 0 gallons per minute and about 30 gallons per minute.

21. A bypass system as recited claim 16, wherein the check valve is modular.

22. A bypass system as recited in claim 16, further comprising an inductor having an inlet in fluid communication with the outlet of the pump, and having an outlet configured and adapted to be placed in fluid communication with the treatment tank.

23. A modular flow restrictor comprising:
a) a first body portion defining a flow inlet, a first flow passage therethrough having a first diameter, the first body portion having a first set of threads thereon;
b) a second body portion defining a flow outlet, the second body portion having a second set of threads adapted and configured to mate with the first set of threads;
c) a third body portion defining a second flow passage therethrough having a second diameter, the second flow passage being in fluid communication with the first flow passage, the third body portion being adapted and configured to be received by the second body portion; and
d) an orifice plate having a body defining a flow orifice therethrough having a third diameter substantially smaller than the first diameter and second diameter, the orifice plate being adapted and configured to be removably captured between the first, second and third body portions when the threads are tightened.

24. A modular check valve comprising:
a) a first body portion defining a flow inlet, a first flow passage therethrough having a first diameter, the first body portion having a first set of threads thereon;
b) a second body portion defining a flow outlet, the second body portion having a second set of threads adapted and configured to mate with the first set of threads;
c) a third body portion defining a second flow passage therethrough having a second diameter, the second flow passage being in fluid communication with the first flow passage, the third body portion being adapted and configured to be received by the second body portion; and
d) a check valve sub-assembly adapted and configured to be removably captured between the first, second and third body portions when the threads are tightened.

25. A modular check valve as recited in clam 24, wherein at least one of the first body portion, the second body portion, the third body portion, and the check valve sub-assembly includes a plastic material.
